(19) United States
(12) Patent Application Publication
(10) Pub. No.: US 2018/0007898 A1
(43) Pub. Date: Jan. 11, 2018

(54) BIOPESTICIDE COMPOSITIONS AND METHODS FOR THEIR PREPARATION AND USE

(71) Applicant: EAST CHINA UNIVERSITY OF SCIENCE AND TECHNOLOGY, Shanghai (CN)

(72) Inventor: Xiaping ZHOU, Shanghai (CN)

(73) Assignee: EAST CHINA UNIVERSITY OF SCIENCE AND TECHNOLOGY, Shanghai (CN)

(21) Appl. No.: 15/534,906

(22) PCT Filed: Nov. 17, 2014
(86) PCT No.: PCT/CN2014/091265

§ 371 Date: Jun. 9, 2017

(51) Int. Cl. A01N 43/16; A01N 25/26; A01N 47/14; A01N 59/16

(52) U.S. Cl. CPC A01N 43/16; A01N 59/16; A01N 25/26; A01N 47/14

(57) ABSTRACT

Biopesticide compositions, and methods and kits for their preparation from lignin are disclosed. A biopesticide may include a modified lignin chelated with one or more pesticides, the one or more pesticides having at least one acidic pesticide. The modified lignin may have one or more functional groups. Methods of producing a biopesticide may include obtaining a lignin, contacting the lignin with one or more bacteria under conditions suitable for producing a modified lignin, and chelating the modified lignin with one or more pesticides, the one or more pesticides having at least one acidic pesticide.

### FIELD

Disclosed are biopesticide compositions, and methods and kits for their preparation from lignin.

### BACKGROUND

Unless otherwise indicated herein, the materials described in this section are not prior art to the claims in this application and are not admitted to be prior art by inclusion in this section.

Biopesticides have an array of bactericidal activity which is in great demand in agricultural markets. Biopesticides are often technically effective, but are challenging to make or provide in a cost-effective manner. Biopesticides may potentially reduce or eliminate the need for chemical pesticides in agriculture, and the accompanying pollution associated with the chemical pesticides. It is therefore desirable to provide biopesticides and methods of making the biopesticides that can address the challenges described above.

### SUMMARY

Disclosed herein are biopesticide compositions. In some embodiments, a biopesticide composition may include a modified lignin chelated with one or more pesticides, the modified lignin having a structure:

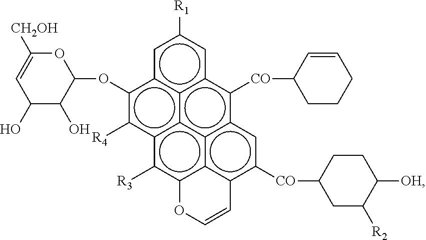

wherein the one or more pesticides include at least one acidic pesticide, and at least one of R₁, R₂, R₃, or R₄ includes one or more functional groups.

Also disclosed herein are methods of producing a biopesticide composition. In some embodiments, a method of producing a biopesticide composition may include obtaining a lignin having a structure,

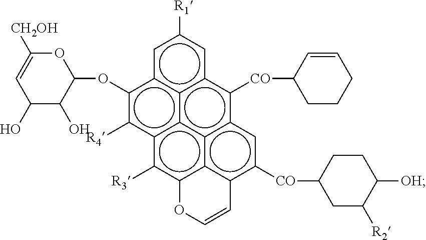

contacting the lignin with one or more bacteria under conditions suitable for producing a modified lignin having at least one of R′₁, R′₂, R′₃, R′₄ or substituted with one or more functional groups (not hydrogen); and chelating the modified lignin with one or more pesticides, the one or more pesticides including at least one acidic pesticide.

In some embodiments, a method of producing a biopesticide composition may include obtaining a lignin having a structure,

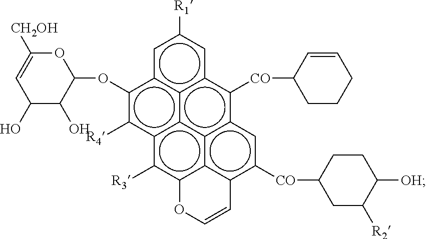

contacting the lignin with one or more halophilic bacteria at a reaction temperature of about 10° C. to about 60° C. and a reaction time of about 10 hours to about 80 hours to produce a modified lignin having at least one of R′₁, R′₂, R′₃, or R′₄ substituted with one or more functional groups (not hydrogen); and chelating the modified lignin with one or more pesticides, the one or more pesticides including at least one acidic pesticide.

In some embodiments, a method of producing a biopesticide composition may include obtaining a lignin having a structure,

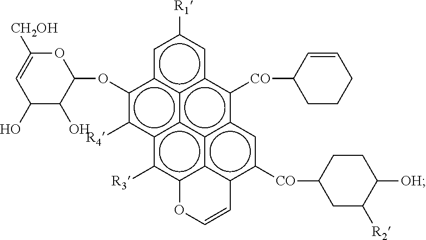

contacting the lignin with one or more alkalophilic bacteria at a reaction temperature of about 5° C. to about 40° C. and a reaction time of about 5 hours to about 60 hours to produce a modified lignin having at least one of R′₁, R′₂, R′₃, or R′₄ substituted with one or more functional groups (not hydrogen); and chelating the modified lignin with one or more pesticides, the one or more pesticides including at least one acidic pesticide.

Further disclosed herein are kits for producing a biopesticide composition. In some embodiments, the kit may include a lignin having a structure

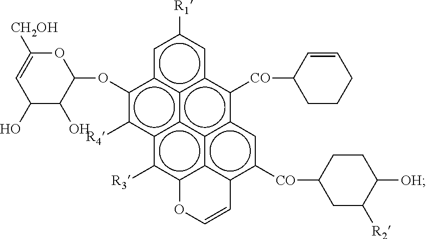

one or more bacteria; one or more reagents for producing a modified lignin having at least one of R′₁, R′₂, R′₃, or R′₄ substituted with one or more functional groups (not hydrogen); and one or more reagents for chelating the modified lignin with one or more pesticides.

The foregoing summary is illustrative only and is not intended to be in any way limiting. In addition to the illustrative aspects, embodiments, and features described above, further aspects, embodiments, and features will become apparent by reference to the following detailed description.

### DETAILED DESCRIPTION

### General

Disclosed herein are biopesticide compositions, and methods and kits for producing biopesticide compositions from lignin. The biopesticide compositions prepared by the methods and kits disclosed herein can be degradable, and configurable to be a sustained-release preparation.

### Compositions

In some embodiments, a biopesticide composition may include a modified lignin chelated with one or more pesticides, the modified lignin having a structure:

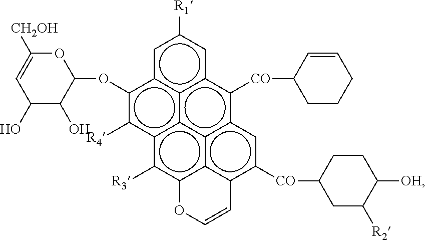

the one or more pesticides having at least one acidic pesticide, and at least one of R₁, R₂, R₃, or R₄ having one or more functional groups (not hydrogen).

In some embodiments, the modified lignin can be an oxidized lignin, and at least one of R₁, R₂, R₃, or R₄ may include one or more oxygen-containing functional groups. In some embodiments, the one or more oxygen-containing functional groups may include one or more carboxyl groups, one or more phenolic groups, one or more carbonyl ((C═O) groups, one or more (—CH═CHOH) groups, one or more methoxyl (—OCH₃) groups, or any combination thereof.

In some embodiments, the modified lignin can be a sulfonated lignin, and at least one of R₁, R₂, R₃, or R₄ includes one or more sulfonic acid functional groups.

In some embodiments, at least one of R₁, R₂, R₃, or R₄ of the modified lignin can have a structure:

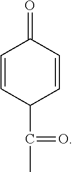

In some embodiments, at least one of R₁, R₂, R₃, or R₄ of the modified lignin can have a structure:

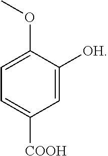

In some embodiments, at least one of R₁, R₂, R₃, or R₄ of the modified lignin can have a structure:

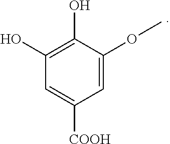

In some embodiments, at least one of R₁, R₂, R₃, or R₄ of the modified lignin can have a structure:

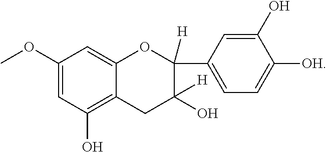 [SMILES: COc1cc(O)c2c(c1)OC(c1ccc(O)c(O)c1)C(O)C2]

Combinations of the structures listed above for at least one of R₁, R₂, R₃, or R₄ of the modified lignin may also be used. In some examples, R₁ and R₃ may both be the same structure.

In a non-limiting example, a modified lignin can have a structure:

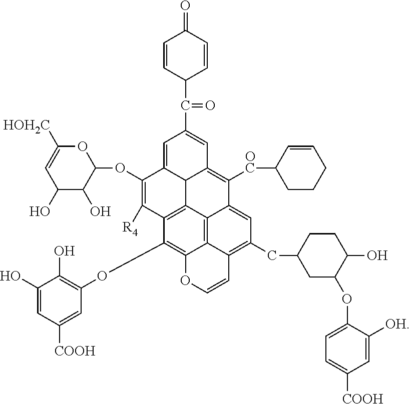

Non-limiting examples of the at least one acidic pesticide that can be chelated with the modified lignin may include Mancozeb (ethylene bis[dithiocarbamato]manganese mixture with ethylenebis[dithio-carbamato]zinc). Carbendazim (N-(2-benzimidazolyl)-methyl carbamate), Fenvalerate ((S)-α-cyano-3-phenoxybenzyl(S)-2-(4-chlorophenyl)-3-methylbutyrate 2), Furadan (2,3-dihydro-2,2-dimethyl-7-benzofuranyl-methylcarbamate), Benzoyl cyanide-O-(diethyoxyphosphinothioyl)oxime, O,O-diethyl-O-(phenylacetonitrile oxime), or any combination thereof. In some embodiments, the at least one pesticide may include Mancozeb (ethylene bis[dithiocarbamato]manganese mixture with ethylenebis[dithio-carbamato]zinc).

In some embodiments, the biopesticide composition can be degradable. In further embodiments, the biopesticide composition can be degradable into trace elements, zinc, manganese, humic acid, or any combination thereof. In some embodiments, the biopesticide composition can be configured to be a sustained-release preparation. In some embodiments, the sustained-released preparation may include the biopesticide composition, and a sustained-release layer at least partially surrounding the biopesticide composition. In some embodiments, the sustained-release layer may completely surround the biopesticide composition. In some embodiments, the sustained-release, layer can be configured to allow the biopesticide composition to permeate through the sustained-release layer. For example, the sustained-release layer may be a membrane that allows the biopesticide composition to permeate through so that the biopesticide composition can be delivered in a predetermined rate over a period of time. In some embodiments, the sustained-release layer can include mannitol, dextrin, starch, xylose, or any combination thereof. In some embodiments, the sustained-release preparation may have a pH of about 4 to about 7. For example, in some embodiments, the sustained-release preparation can have a pH of about 4, about 4.5, about 5, about 5.5, about 6, about 6.5, about 7, or a pH between any two of these values (including endpoints). in some embodiments, the sustained-release preparation can have a pH of about 5.

### Methods of Producing a Biopesticide

In some embodiments, a method for producing a biopesticide composition may include obtaining a lignin having a structure,

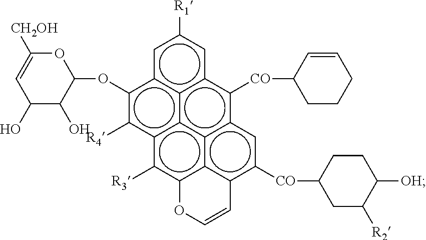

contacting the lignin with one or more bacteria under conditions suitable for producing a modified lignin having at least one of R′₁, R′₂, R′₃, or R′₄ substituted with one or more functional groups (not hydrogen); and chelating the modified lignin with one or more pesticides, the one or more pesticides having at least one acidic pesticide. In some embodiments, at least one of R′₁, R′₂, R′₃, or R′₄ of the lignin can include a carboxyl (—COOH) group, carbonyl (C═O) group, a (—CH═CHOH) group, a methoxyl (—OCH₃) group, or any combination thereof.

The temperature at which the contacting step is performed can vary, depending on the embodiment. In some embodiments, the contacting step may include contacting the lignin with the one or more bacteria at a temperature of about 5° C. to about 60° C. For example, the contacting step may include contacting the lignin with the one or more bacteria at a temperature of about 5° C. about 10° C., about 15° C., about 20° C., about 25° C., about 30° C., about 35° C., about 40° C., about 45° C., about 50° C., about 55° C., about 60° C., or a temperature between any two of these values (including endpoints). In some embodiments, the contacting step may include contacting the lignin with the one or more bacteria at a temperature of about 10° C. to about 30° C. In some embodiments, the contacting step may include contacting the lignin with the one or more bacteria at a temperature of about 20° C. to about 35° C. In some embodiments, the contacting step may include contacting the lignin with the one or more bacteria at a temperature of about 20° C. to about 40° C. In some embodiments, the contacting step may include contacting the lignin with the one or more bacteria at a temperature of about 30° C. to about 50° C.

The length of time for which the contacting step can occur can vary, depending on the embodiment. In some embodiments, the contacting step may include contacting the lignin with the one or more bacteria for at least about 5 hours, or about 5 hours to about 170 hours. For example, the contacting step may include contacting the lignin with the one or more bacteria for about 5 hours, about 10 hours, about 15 hours, about 20 hours, about 25 hours, about 30 hours, about 35 hours, about 40 hours, about 45 hours, about 50 hours, about 55 hours, about 60 hours, about 65 hours, about 70 hours, about 75 hours, about 80 hours, about 85 hours, about 90 hours, about 95 hours, about 100 hours, about 110 hours, about 120 hours, about 130 hours, about 140 hours, about 150 hours, about 160 hours, about 170 hours, or a length of time between any of these values (including endpoints). in some embodiments, the contacting step may include contacting the lignin with the one or more bacteria for about 5 hours to about 80 hours. In some embodiments, the contacting step may include contacting the lignin with the one or more bacteria for about 10 hours to about 80 hours. In some embodiments, the contacting step may include contacting the lignin with the one or more bacteria for about 10 hours to about 50 hours. In some embodiments, the contacting step may include contacting the lignin with the one or more bacteria for about 12 hours to about 50 hours. In some embodiments, the contacting step may include contacting the lignin with the one or more bacteria for about 10 hours to about 55 hours. In some embodiments, the contacting step may include contacting the lignin with the one or more bacteria for about 15 hours to about 75 hours.

In some embodiments, contacting the lignin with the one or more bacteria may include contacting the lignin with one or more halophilic bacteria. Non-limiting examples of the one or more halophilic bacteria may include Actinomycetes, Bacillus, Pseudomonas, Halococcus, Halobacterium halobium, Halobacterium cutirubrum, or any combination thereof.

In some embodiments, contacting the lignin with the one or more halophilic bacteria may include contacting the lignin with one or more enzymes produced by the halophilic bacteria. Non-limiting examples of the one or more enzymes may include oxidase, cytoplasmic enzyme, metalloenzyme, cellulase, xylanase, Bacillopeptidase B, proteolytic enzyme, catalase, or any combination thereof.

In some embodiments, contacting the lignin with the one or more bacteria comprises contacting the lignin with one or more acidophilic bacteria. Non-limiting examples of the one or more acidophilic bacteria may include Thiobacillus caldus, Leptospirillum ferrooxidans or any combination thereof. In some embodiments, contacting the lignin with the one or more acidophilic bacteria may include contacting the lignin with one or more enzymes produced by the acidophilic bacteria.

In some embodiments, contacting the lignin with the one or more bacteria may include contacting the lignin with one or more alkalophilic bacteria. Non-limiting examples of the one or more alkalophilic bacteria may include Azobacter, Bacillus, Pseudomonas, Synechococcus, Bacillus firmus RAB, Spirulina spp, Alicyclobacillus or any combination thereof.

In some embodiments, contacting the lignin with the one or more alkalophilic bacteria may include contacting the lignin with, one or more enzymes produced by the alkalophilic bacteria. Non-limiting examples of the one or more enzymes may include alkaline protease, alkaline cellulose, alkaline amylase, sulfurylase, phosphorylase, alkaline xylanase, cellulose, or any combination thereof.

In some embodiments, contacting the lignin with the one or more bacteria may include contacting the lignin with a combination of bacteria. For example, the one or more bacteria can include a combination of one or more halophilic bacteria, one or more alkalophilic bacteria, and/or one or more acidophilic bacteria.

In some embodiments, the method may further include acclimating the one or more bacteria before contacting with the lignin. The acclimating of the one of more bacteria may include growing the one or more bacteria at a predetermined pH, predetermined temperature, or both. In some embodiments, the one or more bacteria can be grown in a culture medium. The culture medium may include a water soluble extract of lignin, an organic acid, agar powder, nitrogen source, or any combination thereof. The organic acid can for example be phytic acid, citric acid, or other acids. The nitrogen source can for example be peptone, tryptone, yeast extract, or any combination thereof. In some examples, the culture medium is a Luria Broth (LB) culture medium. The pH of the culture medium may be dependent on the pH at which the one or more bacteria is acclimated. In some embodiments, the culture medium may have a pH of about 3.5 to about 8.0. For example, in some embodiments, the pH can be about 3.5, about 4.0, about 4.5, about 5.0, about 5.5, about 6.0, about 6.5, about 7.0, about 7.5, about 8.0, or a pH between any two of these values (including endpoints). In some embodiments, the one or more bacteria can be acclimated at a temperature of about 10° C. to about 50° C. For example, the bacteria can be acclimated at a temperature of about 10° C., about 15° C., about 20° C., about 25° C., about 30° C., about 35° C., about 40° C., about 45° C., about 50° C., or a temperature between any two of these values. In some embodiments, the pH and/or temperature at which the acclimating of the bacteria is carried out may be substantially similar to the pH and/or temperature at which the lignin is contacted with the bacteria to produce the modified lignin. Thus, certain strains of bacteria, which may typically grow in pH ranges and/or temperature ranges that are not within suitable ranges for lignin modification, can be acclimated to the suitable pH ranges and/or temperature ranges for lignin modification. The growth of the one or more bacteria at a pH of about 3.5 to about 8.0 and/or at a temperature of about 10° C. to about 50° C. can result in an increased growth of the bacteria. Conversely, use of conditions with a pH of less than about 3.5 or greater than about 8.0 (or temperatures less than about 10° C. or greater than about 50° C.) can be used to decelerate bacterial growth, if reductions in growth rate are amenable for the lignin modification reaction.

In some embodiments, contacting the lignin with the one or more bacteria can produce an oxidized lignin as the modified lignin, and at least one of R′₁, R′₂, R′₃, or R′₄ can be substituted with one or more oxygen-containing functional groups. In some embodiments, the one or more oxygen-containing functional groups may include one or more carboxyl groups, one or more phenolic groups, one or more carbonyl (C═O) groups, one or more (—CH═CHOH) groups, one or more methoxyl (—OCH₃) groups, or any combination thereof.

In some embodiments, contacting the lignin with the one or more bacteria can produce sulfonated lignin as the modified lignin, and at least one of R′₁, R′₂, R′₃, or R′₄ can be substituted with one or more sulfonic acid functional groups.

In some embodiment, at least one of R′₁, R′₂, R′₃, or R′₄ of the lignin can be substituted with:

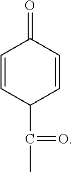

In some embodiments, at least one of R′₁, R′₂, R′₃, or R′₄ of the lignin can be substituted with:

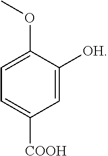

In some embodiments, at least one of R′₁, R′₂, R′₃, or R′₄ of the lignin can be substituted with:

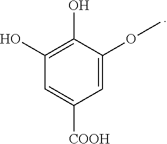

In some embodiments, at least one of R′₁, R′₂, R′₃, or R′₄ of the lignin can be substituted with:

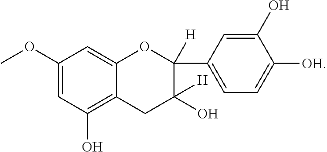 [SMILES: COc1cc(O)c2c(c1)OC(c1ccc(O)c(O)c1)C(O)C2]

In a non-limiting example, the modified lignin can have a structure:

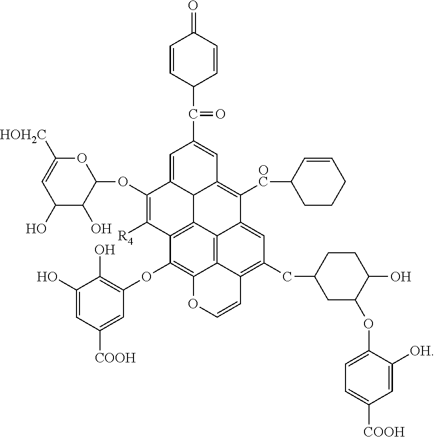

in some embodiments, the lignin can be waste lignin. In some embodiments, the waste lignin can be a liquid. In some embodiments, the waste lignin maybe sourced from paper manufacturing, ethanol production, or any combination thereof. In some embodiments, a biopesticide composition can be produced by the methods disclosed herein.

In some embodiments, a method of producing a biopesticide composition can include obtaining a lignin having a structure,

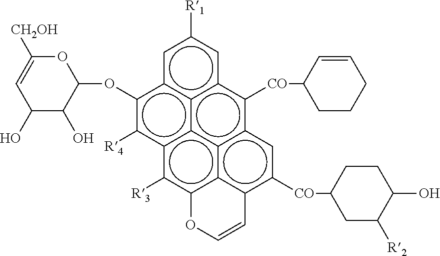

contacting the lignin with one or more halophilic bacteria at a reaction temperature of about 10° C. to about 60° C. and a reaction time of about 10 hours to about 80 hours to produce a modified lignin having at least one of R′₁, R′₂, R′₃, or R′₄ substituted with one or more functional groups (not hydrogen); and chelating the modified lignin with one or more pesticides, the one or more pesticides including at least one acidic pesticide.

Non-limiting examples of the one or more halophilic bacteria may include Actinomycetes, Bacillus, Pseudomonas, Halococcus, Halobacterium halobium, Halobacterium cutirubrum, or any combination thereof.

In some embodiments, contacting the lignin with the one or more halophilic bacteria may include contacting the lignin with one or more enzymes produced by the halophilic bacteria. Non-limiting examples of the one or more enzymes may include oxidase, cytoplasmic enzyme, metalloenzyme, cellulase, xylanase, Bacillopeptidase B, proteolytic enzyme, catalase, or any combination thereof.

In some embodiment, the method may further include acclimating the one or more halophilic bacteria before contacting with the lignin. The acclimating of the one or more halophilic bacteria may include growing the one or more halophilic bacteria at a predetermined pH, predetermined temperature, or both. In some embodiments, the one or more halophilic bacteria can be grown using a culture medium. The culture medium may include a water soluble extract of lignin, organic acid, agar powder, nitrogen source or any combination thereof. The organic acid can for example be phytic acid, citric acid or other acids. The nitrogen source can for example be peptone, tryptone, yeast extract, or any combination thereof. In some examples, the culture medium is a Luria Broth (LB) culture medium. The pH of the culture medium may be dependent on the pH at which the one or more halophilic bacteria is acclimated. In some embodiments, the culture medium may have a pH of about 3.5 to about 8.0. For example, in some embodiments, the pH can be about 3.5, about 4.0, about 4.5, about 5.0, about 5.5, about 6.0, about 6.5, about 7.0, about 7.5, about 8.0, or a pH between any two of these values (including endpoints). In some embodiments, the one or more halophilic bacteria can be acclimated at a temperature of about 10° C. to about 50° C. For example, the halophilic bacteria can be acclimated at a temperature of about 10° C., about 15° C., about 20° C., about 25° C., about 30° C., about 35° C., about 40° C., about 45° C., about 50° C., or a temperature between any two of these values (including endpoints). In some embodiments, the pH and/or temperature at which the acclimating of the halophilic bacteria is carried out may be substantially similar to the pH and/or temperature at which the lignin is contacted with the halophilic bacteria to produce the modified lignin. Thus, certain strains of halophilic bacteria, which may typically grow in pH ranges and/or temperature ranges that are not within suitable ranges for lignin modification, can be acclimated to the suitable pH ranges and/or temperature ranges for lignin modification. The growth of the one or more halophilic bacteria at a pH of about 3.5 to about 8.0 and/or at a temperature of about 10° C. to about 50° C. can result in an increased growth of the bacteria. Conversely, use of conditions with a pH of less than about 3.5 or greater than about 8.0 (or temperatures less than about 10° C. or greater than about 50° C.) can be used to decelerate bacterial growth, if reductions in growth rate are amenable for the lignin modification reaction.

In some embodiments, contacting the lignin with the one or more halophilic bacteria can produce an oxidized lignin as the modified lignin, and at least one of R′₁, R′₂, R′₃, or R′₄ can be substituted with one or more oxygen-containing functional groups. In some embodiments, the one or more oxygen-containing functional groups can include one or more carboxyl groups, one or more phenolic groups, one or more carbonyl (C═O) groups, one or more (—CH═CHOH) groups, one or more methoxyl (—OCH₃) groups, or any combination thereof.

In some embodiments, contacting the lignin with the one or more halophilic bacteria can produce sulfonated lignin as the modified lignin, and at least one of R′₁, R′₂, R′₃, or R′₄ can be substituted with one or more sulfonic acid functional groups.

In some embodiments, a method of producing a biopesticide composition can include obtaining a lignin having a structure,

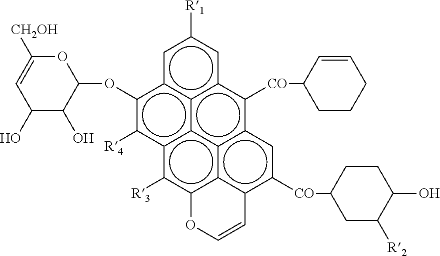

contacting the lignin with one or more alkalophilic bacteria at a reaction temperature of about 5° C. to about 40 and a reaction time of about 5 hours to about 60 hours to produce a modified lignin having at least one of R′₁, R′₂, R′₃, or R′₄ substituted with one or more functional groups (not hydrogen); and chelating the modified lignin with one or more pesticides, the one or more pesticides including at least one acidic pesticide.

Non-limiting examples of the alkalophilic bacteria may include Azobacter, Bacillus, Pseudomonas, Synechococcus, Bacillus firmus RAB, Spirulina spp. Alicyclobacillus or any combination thereof.

In some embodiments, contacting the lignin with the one or more alkalophilic bacteria may include contacting the lignin with one or more enzymes produced by the alkalophilic bacteria. Non-limiting examples of the one or more enzymes may include alkaline protease, alkaline cellulose, alkaline amylase, sulfurylase, phosphorylase, alkaline xylanase, cellulose, or any combination thereof.

In some embodiments, the method may further include acclimating the one or more alkalophilic bacteria before contacting with the lignin. The acclimating of the one or more alkalophilic bacteria may include growing the one or more alkalophilic bacteria at a predetermined pH, predetermined temperature, or both. In some embodiments, the one or more alkalophilic bacteria can be grown using a culture medium. The culture medium may include a water soluble extract of lignin, organic acid, agar powder, nitrogen source or any combination thereof. The organic acid can for example be phytic acid, citric acid, or other acids. The nitrogen source can for example be peptone, tryptone, yeast extract, or any combination thereof. In some examples, the culture medium is a Luria Broth (LB) culture medium. The pH of the culture medium may be dependent on the pH at which the one or more alkalophilic bacteria is acclimated. In some embodiments, the culture medium, may have a pH of about 3.5 to about 8.0. For example, in some embodiments, the pH can be about 3.5, about 4.0, about 4.5, about 5.0, about 5.5, about 6.0, about 6.5, about 7.0, about 7.5, about 8.0, or a pH between any two of these values (including endpoints). In some embodiments, the one or more alkalophilic bacteria can be acclimated at a temperature of about 10° C. to about 50° C. For example, the alkalophilic bacteria can be acclimated at a temperature of about 10° C., about 15° C., about 20° C., about 25° C., about 30° C., about 35° C., about 40° C., about 45° C., about 50° C., or a temperature between any two of these values (including endpoints). In some embodiments, the pH and/or temperature at which the acclimating of the alkalophilic bacteria is carried out may be substantially similar to the pH and/or temperature at which the lignin is contacted with the alkalophilic bacteria to produce the modified lignin. Thus, certain strains of alkalophilic bacteria, which may typically grow in pH ranges and/or temperature ranges that are not within suitable ranges for lignin modification, can be acclimated to the suitable pH ranges and/or temperature ranges for lignin modification. The growth of the one or more alkalophilic bacteria at a pH of about 3.5 to about 8.0 and/or at a temperature of about 10° C. to about 50° C. can result in an increased growth of the bacteria. Conversely, use of conditions with a pH of less than about 3.5 or greater than about 8.0 (or temperatures less than about 10° C. or greater than about 50° C.) can be used to decelerate bacterial growth, if reductions in growth rate are amenable for the lignin modification reaction.

In some embodiments, contacting the lignin with the one or more alkalophilic bacteria can produce an oxidized lignin as the modified lignin, and the at least one of R′₁, R′₂, R′₃, or R′₄ can be substituted with one or more oxygen-containing functional groups. In some embodiments, the one or more oxygen-containing functional groups may include one or more carboxyl groups, one or more phenolic groups, one or more carbonyl (C═O) groups, one or more (—CH═CHOH) groups, one or more methoxyl (—OCH₃) groups, or any combination thereof.

In some embodiments, contacting the lignin with the one or more alkalophilic bacteria can produce sulfonated lignin as the modified lignin, and at least one of R₁, R₂, R₃, or R₄can be substituted with one or more sulfonic acid functional groups.

### Kits for Producing Biopesticides

In some embodiments, a kit for producing a biopesticide composition may include a lignin having a structure,

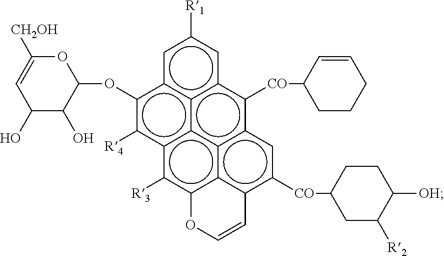

one or more bacteria; one or more reagents for producing a modified lignin having at least one of R′₁, R′₂, R′₃, or R′₄ substituted with one or more functional groups (not hydrogen); and one or more reagents for chelating the modified lignin with one or more pesticides. In some embodiments, the kit can further include instructions for contacting the lignin with the one or more bacteria under conditions suitable for producing a modified lignin having at least one of R′₁, R′₂, R′₃, or R′₄ substituted with one or more functional groups (not hydrogen), and chelating the modified lignin with one or more pesticides. In some embodiments, the kit can include one or more pesticides. In some embodiments, the one or more pesticides can include at least one acidic pesticide.

In some embodiments, the at least one of R′₁, R′₂, R′₃, or R′₄ of the lignin may include a carboxyl (—COOH) group, carbonyl (C═O) group, a (—CH═CHOH) group, a methoxyl (—OCH₃) group, or any combination thereof.

In some embodiments, the lignin can be a waste lignin. In some embodiments, the waste lignin can be a liquid. In some embodiments, the waste lignin may be sourced from paper manufacturing, ethanol production, or any combination thereof.

In some embodiments, the one or more bacteria can include one or more halophilic bacteria. Non-limiting examples of the one or more halophilic bacteria can include Actinomycetes, Bacillus, Pseudomonas, Halococcus, Halobacterium halobium, Halobacterium cutirubrum, or combination thereof.

In some embodiments, the one or more bacteria can include one or more alkalophilic bacteria. Non-limiting examples of the one or more alkalophilic bacteria may include Azobacter, Bacillus, pseudomonas, Synechococcus, Bacillus firmus RAB, Spirulina spp, Alicyclobacillus or any combination thereof.

In some embodiments, the one or more bacteria can include one or more acidophilic bacteria. Non-limiting examples of the one or more acidophilic bacteria may include Thiobacillus caldus, Leptospirillum ferrooxidans or any combination thereof.

In some embodiments, the modified lignin can be an oxidized lignin, and at least one of R′₁, R′₂, R′₃, or R′₄ may be substituted with one or more oxygen-containing functional groups. In some embodiments, the one or more oxygen-containing functional groups may include one or more carboxyl groups, one or more phenolic groups, one or more carbonyl (C═M) groups, one or more (—CH═CHOH) groups, one or more methoxyl (—OCH₃) groups, or any combination thereof. In some embodiments, the modified lignin can be a sulfonated lignin, and at least one of R′₁, R′₂, R′₃, or R′₄ may include one or more sulfonic acid functional groups.

In some embodiments, at least one of R′₁, R′₂, R′₃, or R′₄ of the lignin can be substituted with:

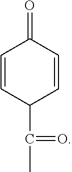

In some embodiments, at least one of R′₁, R′₂, R′₃, or R′₄ of the lignin can be substituted with:

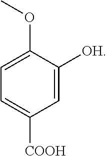

In some embodiments, at least one of R′₁, R′₂, R′₃, or R′₄ of the lignin can be substituted with:

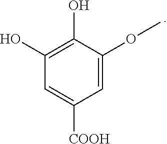

In some embodiments, at least one of R′₁, R′₂, R′₃, or R′₄ of the lignin can be substituted with:

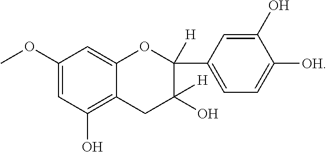 [SMILES: COc1cc(O)c2c(c1)OC(c1ccc(O)c(O)c1)C(O)C2]

In a non-limiting example, the modified lignin can have a structure:

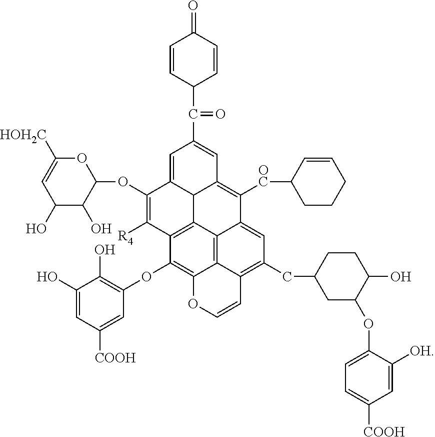

In some embodiments, the at least one acidic pesticide can include Mancozeb (ethylene bis[dithiocarbamato]manganese mixture with ethylenebis[dithio-carbamato]zinc), Carbendazim (N-(2-benzimidazolyl)-methyl carbamate), Fenvalerate ((S)-α-cyano-3-phenoxybenzyl(S)-2-(4-chlorophenyl)-3-methylbutyrate 2), Furadan (2,3-dihydro-2,2-dimethyl-7-benzofuranyl-methylcarbamate), Benzoyl cyanide-O-(diethyoxyphosphinothioyl)oxime, O,O-diethyl-O-(phenylacetonitrile oxime), or any combination thereof. In some embodiments, the at least one acidic pesticide can be Mancozeb (ethylene bis[dithiocarbamato] manganese mixture with ethylenebis[dithio-carbamato]zinc).

In some embodiments, the biopesticide composition can be degradable. In some embodiments, the biopesticide composition can be degradable into trace elements, zinc, manganese, humic acid, or any combination thereof. In some embodiments, the biopesticide composition can be configured to be a sustained-release preparation. In some embodiments, the sustained-released preparation may include the biopesticide composition, and a sustained-release layer at least partially surrounding the biopesticide composition. In some embodiments, the sustained-release layer may completely surround the biopesticide composition. In some embodiments, the sustained-release layer can be configured to allow the biopesticide composition to permeate through the sustained-release layer. For example, the sustained-release layer may be a membrane that allows the biopesticide composition to permeate through so that the biopesticide composition can be delivered in a predetermined rate over a period of time. In some embodiments, the sustained-release layer can include mannitol, dextrin, starch, xylose, or any combination thereof. In some embodiments, the sustained-release preparation may have a pH of about 4 to about 7. For example, in some embodiments, the sustained-release preparation can have a pH or about 4, about 4.5, about 5, about 5.5, about 6, about 6.5, about 7, or a pH between any two of these values. In some embodiments, the sustained-release preparation can have a pH of about 5.

### EXAMPLES

Additional embodiments are disclosed in further detail in the following examples, which are not in any way intended to limit the scope of the claims.

### Example 1

### Preparation of Oxidized Lignin from Waste Lignin Using Halophilic Bacteria and Alkalophilic Bacteria from Red Mud Soil

Halophilic bacteria (Halobacterium halobium) and alkalophilic bacteria (Spirulina spp) screened from red mud soil in Jiangxi China were acclimated in a culture medium (10 g of water-soluble extract of lignin, 10 g of agar powder, 5 g of peptone, and 1,000 ml of deionized water) at a temperature of 39° C. and at a pressure of 0.1 MPa while shaking at 600 rotations per minute until logarithmic phase was reached. The acclimating was carried out in a biochemical reactor (FUS model available from Shanghai Guoqiang Bioengineering Equipment Co., Ltd.) for at least 72 hours, until the bacteria culture expanded by 10 fold in volume. The acclimated halophilic bacteria and alkalophilic bacteria were charged into their respective samples of waste lignin liquid derived from a pulping process in Hangzhou Xinhua Paper Mill at a flow rate of 20 L/h at a temperature of 50° C. and at a pressure of 0.1 MPa for 120 hours to form oxidized lignin. Each of the resulting samples of oxidized lignin included the —COOH functional group which was derived from the —OCH₃ functional group in the waste lignin. Using microfiltration (6.5 KPa, filter aperture of 10 μm), ultrafiltration (membrane aperture of 5000 μm) and nanofiltration (0.15 MPa), contaminants (such as mycelium and/or free salt) were removed from the oxidized lignin samples. The structure of the resulting oxidized lignin samples obtained from contacting waste lignin with the respective types of bacteria were identified by nuclear magnetic resonance (NMR). The structural transformation of the waste lignin to oxidized lignin by the bacterial oxidation was as follows:

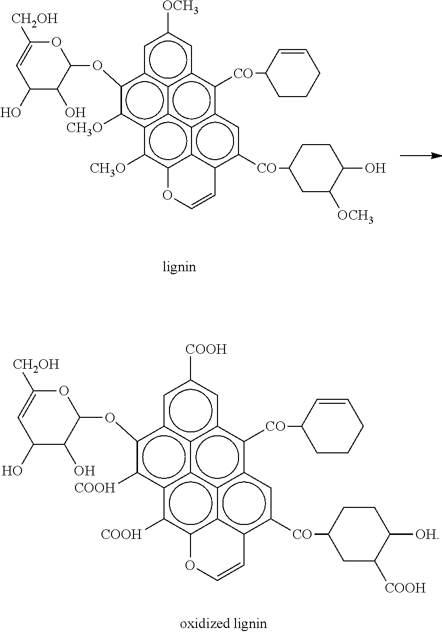

### Example 2

### Preparation of Oxidized Lignin from Waste Lignin Using Alkalophilic Bacteria

Alkalophilic bacteria [Alicyclobacillus (DuPont™ Genencore® Science, China)] was acclimated in a culture medium (10 g of phytic acid, 10 g of agar, 5 g of peptone, and 1000 mL of deionized water) at a temperature of 35° C. and at a pressure of 0.1 MPa while shaking at 200 rotations per minute until logarithmic phase was reached. The acclimating was carried out in a shaking incubator for at least 96 hours, until the bacteria culture expanded by 10 fold in volume, the acclimated alkalophilic bacteria was introduced at a flow rate of 1 L/h into waste lignin liquid at a temperature of 40° C. and at a pressure of 0.1 MPa for 5 days (120 hours) to form an oxidized lignin having the —COOH functional group derived from the —OCH₃ functional group in waste lignin. Using microfiltration (6.5 KPa, filter aperture of 10 μm), ultrafiltration (membrane aperture of 5000 μm) and nanofiltration (0.15 MPa), contaminants (such as mycelium and/or free salt) were removed from the oxidized lignin. The structure of the resulting oxidized lignin was identified by nuclear magnetic resonance (NMR). The structural transformation of the waste lignin to oxidized lignin by the bacterial oxidation was as follows:

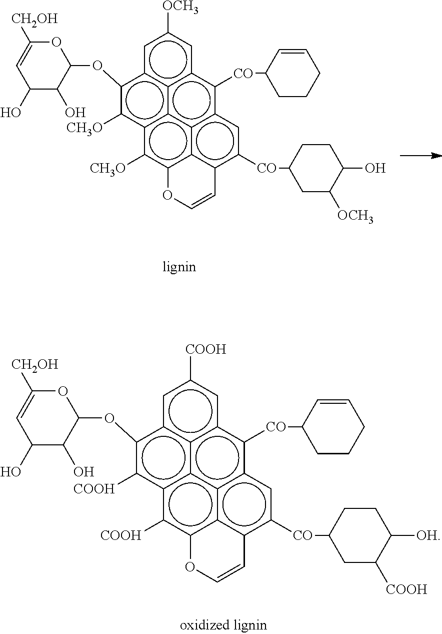

### Example 3

### Preparation of sulfonated Lignin from Waste Lignin Using Halophilic Bacteria and Acidophilic Bacteria from Red Mud Soil

Halophilic bacteria (Halobacterium halobium) and acidophilic bacteria (Thiobacillus caldus and Leptospirillum ferrooxidans) screened from red mud soil in JiangXi China were acclimated in a culture medium (5 g of water-soluble extract lignin, 5 g of agar powder, 5 g of peptone, and 1.000 ml deionized water) at a temperature of 35° C. and at a pressure of 0.18 MPa while shaking at 300 rotations per minute until logarithmic phase was reached. The acclimating was carried out in a biochemical reactor (FUS model, available from Shanghai Guoqiang Bioengineering Equipment Co., Ltd.) for at least 72 hours, until the bacteria culture expanded by 10 fold in volume. The acclimated halophilic bacteria and acclimated acidophilic bacteria were charged into their respective samples of waste lignin liquid derived from the pulping process in Hangzhou Xinhua Paper Mill at a flow rate of 10 L/h at a temperature of 45° C. and at a pressure of 0.11 MPa for 132 hours, to form sulfonated lignin. Each of the resulting samples of sulfonated lignin included the —CH₂SO₃H functional group which was derived from the —OCH₃ functional group in the waste lignin. Using microfiltration (1 KPa, filter aperture of 10 μm), ultrafiltration (flow molecular weight of 1500 Da) and nanofiltration (0.20 MPa, interception, molecular weight of 600 Da), contaminants (such as mycelium and/or free salt) were removed from the sulfonated lignin samples. The structure of the resulting sulfonated lignin samples obtained from contacting waste lignin with the respective types of bacteria were identified by NMR. The structural transformation of the waste lignin to sulfonated lignin by the bacterial sulfonation was as follows:

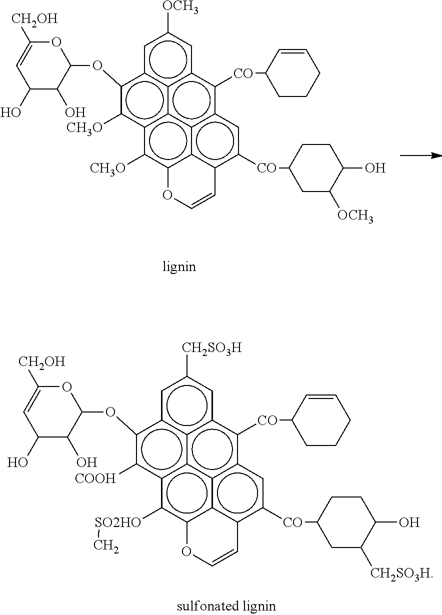

### Example 4

### Preparation of Sulfonated Lignin Using Acidophilic Bacteria

Acidophilic, bacteria [Thiobacillus caldus (Bioengineering Lab 605, East China University of Science of Technology)] was acclimated in a culture medium (10 g of citric acid, 10 g of agar, 5 g of peptone, and 1000 mL of deionized water) at a temperature of 35° C. and at a prepare of 0.1 MPa while shaking at 300 rotations per minute until logarithmic phase was reached. The acclimating was carried out in a shaking incubator for 78 hours, until the bacteria culture expanded by 10 fold in volume. The acclimated acidophilic bacteria was introduced at a flow rate of 1 L/h into waste lignin liquid at a temperature of 50° C. and at a pressure 0.1 MPa for 6 days (144 hours) to form a sulfonated lignin. The sulfonated lignin included the —CH₂SO₃H functional group winch was derived from the —OCH₃ functional group in the waste lignin. Using microfiltration (1 KPa, filter aperture of 10 μm), ultrafiltration (flow molecular weight of 1500 Da) and nanofiltration (0.20 MPa, interception molecular weight of 600 Da), contaminants (such as mycelium and/or free salt) were removed from the sulfonated lignin. The structure of the resulting sulfonated lignin was identified by NMR. The structural transformation of the waste lignin to sulfonated lignin by the bacterial sulfonation was as follows:

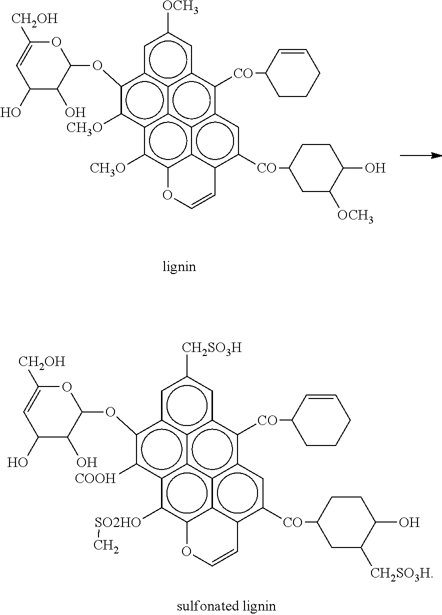

### Example 5

### Chelation of the Modified Lignin with Acidic Pesticide

The oxidized lignin from Examples 1 and 2, and the sulfonated lignin from examples 3 and 4 were analyzed as follows to determine the amount of oxygen-containing functional groups, such as carboxyl groups and phenolic groups. For ease of description, the oxidized lignin and the sulfonated lignin will be generically referred to as “modified lignin”.

The modified lignin was measured for oxygen-containing functional groups using calcium acetate method and barium hydroxide method established in the art.

The calcium acetate method was used to measure the amount of carboxyl groups present in the modified lignin. The modified lignin sample was titrated using excess calcium acetate solution. During the titration, the modified lignin reacts with calcium acetate to form calcium salt and acetate (CH₃COO⁻). Standard (1M) sodium hydroxide was used as needed to neutralize the excess acetic acid.

The barium hydroxide method was used to determine the total amount of acidic groups present in the modified lignin. The modified lignin sample was treated with excess barium hydroxide solution using non-aqueous conductometric titration. The modified lignin reacts with barium hydroxide to form barium, salt. Standard (1M) hydrochloric acid was used as needed to neutralize the excess barium hydroxide.

The amount of phenolic hydroxyl groups present in the modified lignin was calculated by subtracting the amount of carboxyl groups from the total amount of acidic groups. Subsequently, the mass of Mancozeb (acidic pesticide) for chelating the modified lignin was determined. The modified lignin was chelated with the Mancozeb as will be described in Examples 6 and 7.

The resultant biopesticides “ligno (oxidized)-Mancozeb” and “lingo (sulfonated)-Mancozeb” were detected for elements and functional groups by biomass spectrometry and Nuclear Magnetic Resonance (NMR). Their functional structures were as follows:

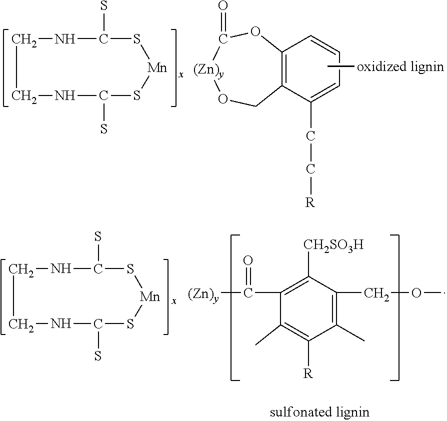

### Example 6

### Structure of a Biopesticide Having an Oxidized Lignin Chelated with Mancozeb

100 g of the oxidized lignin from Example 1 was placed into a stirred reactor. The amount of carboxyl and hydroxyl groups present in the oxidized lignin were determined by the methods described in Example 5. The amount of carboxyl groups present in the oxidized lignin was measured to be 0.192×10⁻³ mol/g by the calcium acetate method. The amount of total acidic groups present in the oxidized lignin was measured to be 0.25×10⁻³ mol/g by the barium hydroxide method. The amount of phenolic hydroxyl groups was calculated to be 0.058×10⁻³ mol/g by subtracting the amount of carboxyl groups from the total amount of acidic groups.

A chelation reaction between the oxidized lignin and Mancozeb (acidic pesticide) was performed at a temperature of 115° C. and at a pressure of 1.7 kg/cm² for 3 hours. The mass of the resulting oxidized lignin-Mancozeb pesticide composition was 1489.

The oxidized lignin-Mancozeb pesticide has the following structure:

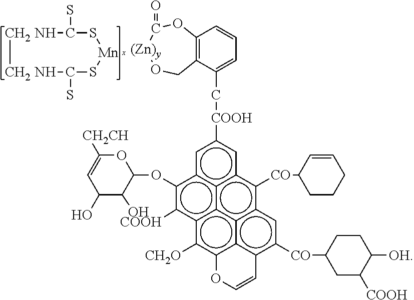

### Example 7

### Structure of a Biopesticide Having a Sulfonated Lignin Chelated with Mancozeb

100 g of the sulfonated lignin modified by a microorganism in Example 3 was placed into a stirred reactor. For the sulfonated lignin obtained by the method described in Example 3, the amount of carboxyl and hydroxyl groups was determined by the methods described in Example 5. Carboxyl groups were measured to be 0.131×10⁻³ mol/g and phenolic groups were measured to be 0.049 mol/g. Dehydrogenation, dehydration and a chelation reaction with a coordinated metal were performed at 118° C. and at a pressure of 1.9 kg/cm². The Mancozeb chelated sulfonated lignin pesticide had a structure as shown below and a molecular weight of 1697. The chelated pesticide has the following structure:

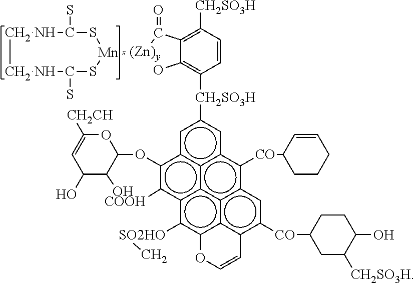

The Examples demonstrate that waste lignin can be processed into biopesticides, thereby providing a low cost raw material for making the biopesticides. The resulting biopesticides are environmentally-friendly and can avoid pollution associated with chemical pesticides in agricultural production.

With respect to the use of substantially any plural and/or singular terms herein, those having skill in the art can translate from the plural to the singular and/or from the singular to volume of wastewater can be received in the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including”) should be interpreted as “including but not limited to,” the term “having” should be interpreted as “having at least” the term “includes” should be interpreted as “includes but is not limited to,” and so on). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, and so on” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, and so on). In those instances where a convention analogous to “at least one of A, B, or C, and so on” is used, in general such a construction is intended in the sense one having skill in the art would understand the convention (for example, “a system having at least one of A, B, or C” would include but not he limited to systems that have A alone, B alone, C alone, A and B together, A and C together, B and C together, and/or A, B, and C together, and so on). It will be further understood, by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, and so on. As a non-limiting example, each range discussed herein can be readily broken down into a lower third, middle third and upper third, and so on. As will also be understood by one skilled in the art all language such-as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A biopesticide composition, comprising:
a modified lignin chelated with one or more pesticides, the modified lignin having a structure: 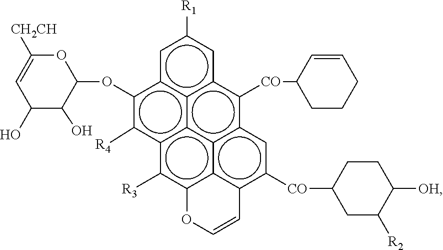
wherein the one or more pesticides comprise at least one acidic pesticide, and
wherein at least one of R₁, R₂, R₃, or R₄comprises one or more functional groups.

2. The biopesticide composition of claim 1, wherein at least one of R₁, R₂, R₃, or R₄has a structure:

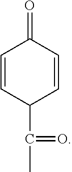

3. The biopesticide composition of claim 1, wherein at least one of R₁, R₂, R₃, or R₄ has a structure:

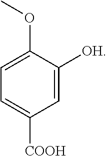

4. The biopesticide composition of claim 1, wherein at least one of R₁, R₂, R₃, or R₄ has a structure:

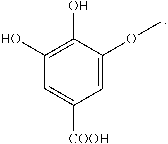

5. The biopesticide composition of claim 1, wherein at least one of R₁, R₂, R₃, or R₄ has a structure:

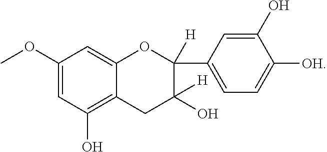 [SMILES: COc1cc(O)c2c(c1)OC(c1ccc(O)c(O)c1)C(O)C2]

6. The biopesticide composition of claim 1, wherein the modified lignin has a structure: 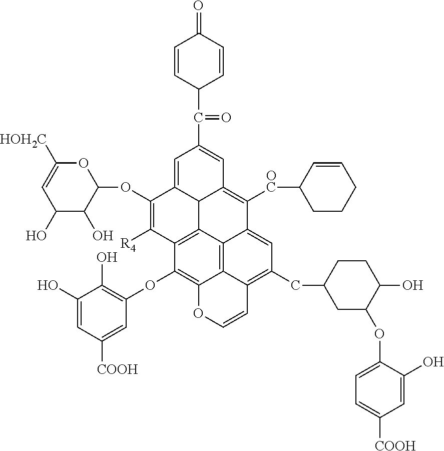
wherein R₄ comprises one or more functional groups.

7. The biopesticide composition of claim 1, wherein the modified lignin is an oxidized lignin, and at least one of R₁, R₂, R₃, or R₄comprises one or more oxygen-containing functional groups, wherein the one or more oxygen-containing functional groups comprise at least one of carboxyl groups, or phenolic groups, or carbonyl (C═O) groups, or (—CH═CHOH) groups, or methoxyl (—OCH₃) groups, or any combination thereof.

8. (canceled)

9. The biopesticide composition of claim 1, wherein the modified lignin is a sulfonated lignin, and at least one of R₁, R₂, R₃, or R₄ comprises one or more sulfonic acid functional groups.

10. The biopesticide composition of claim 1, wherein the at least one acidic pesticide comprises Mancozeb (ethylene bis[dithiocarbamato]manganese mixture with ethylenebis[dithiocarbamato]zinc), Carbendazim (N-(2-benzimidazolyl)-methyl carbamate), Fenvalerate ((S)-α-cyano-3-phenoxybenzyl(S)-2-(4-chlorophenyl)-3-methylbutyrate 2), Furadan (2,3-dihydro-2,2-dimethyl-7-benzofuranyl-methylcarbamate), Benzoyl cyanide-O-(diethoxyphosphinothioyl)oxime, O,O-diethyl-O-(phenylacetonitrile oxime), or any combination thereof.

11. (canceled)

12. (canceled)

13. The biopesticide composition of claim 1, wherein the biopesticide composition is degradable into trace elements, zinc, manganese, humic acid, or any combination thereof.

14. The biopesticide composition of claim 1, configured to be a sustained-release preparation, wherein the sustained-release preparation has a pH of about 4 to about 7.

15. The biopesticide composition of claim 14, wherein the sustained-released preparation comprises the biopesticide composition, and a sustained-release layer at least partially surrounding the biopesticide composition.

16. The biopesticide composition of claim 15, wherein the sustained-release layer completely surrounds the biopesticide composition.

17. The biopesticide composition of claim 15, wherein the sustained-release layer is configured to allow the biopesticide composition to permeate through the sustained-release layer.

18. The biopesticide composition of claim 15, wherein the sustained-release layer comprises mannitol, dextrin, starch, xylose, or any combination thereof.

19. (canceled)

20. (canceled)

21. A method of producing a biopesticide composition, the method comprising:
obtaining a lignin having a structure 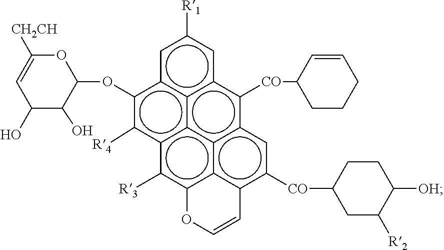
contacting the lignin with one or more bacteria under conditions suitable for producing a modified lignin having at least one of R′₁, R′₂, R′₃, or R′₄ substituted with one or more functional groups; and
chelating the modified lignin with one or more pesticides, wherein the one or more pesticides comprise at least one acidic pesticide.

22. The method of claim 21, wherein at least one of R′₁, R′₂, R′₃, or R′₄ of the lignin comprises a carboxyl (—COOH) group, carbonyl (C═O) group, a (—CH═CHOH) group, a methoxyl (—OCH₃) group, or any combination thereof.

23. The method of claim 21, wherein at least one of R′₁, R′₂, R′₃, or R′₄ of the lignin is substituted with:

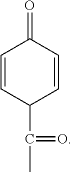

24. The method of claim 21, wherein at least one of R′₁, R′₂, R′₃, or R′₄ of the lignin is substituted with:

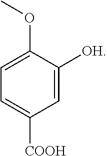

25. The method of claim 21, wherein at least one of R′₁, R′₂, R′₃, or R′₄ of the lignin is substituted with:

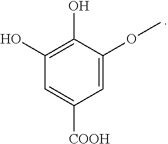

26. The method of claim 21, wherein at least one of R′₁, R′₂, R′₃, or R′₄ of the lignin is substituted with:

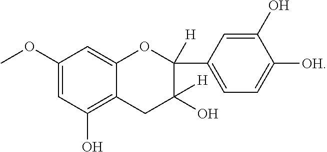 [SMILES: COc1cc(O)c2c(c1)OC(c1ccc(O)c(O)c1)C(O)C2]

27. The method of claim 21, the modified lignin has a structure: 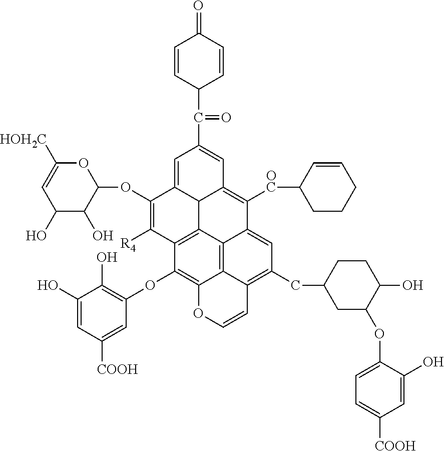
wherein R₄ comprises one or more functional groups.

28. The method of claim 21, wherein contacting the lignin with the one or more bacteria comprises contacting the lignin with at least one of halophilic bacteria, or alkalophilic bacteria or acidophilic bacteria.

29. The method of claim 28, wherein the one or more halophilic bacteria comprise Actinomycetes, Bacillus, Pseudomonas, Halococcus, Halobacterium halobium, Halobacterium cutirubrum, or any combination thereof.

30. The method of claim 28, wherein contacting the lignin with the one or more halophilic bacteria comprises contacting the lignin with one or more enzymes produced by the halophilic bacteria, wherein the one or more enzymes comprise oxidase, cytoplasmic enzyme, metalloenzyme, cellulase, xylanase, Bacillopeptidase B, proteolytic enzyme, catalase, or any combination thereof.

31. (canceled)

32. (canceled)

33. The method of claim 21, wherein the one or more acidophilic bacteria comprises Thiobacillus caldus, Leptospirillum ferrooxidans or any combination thereof.

34. The method of claim 21, wherein contacting the lignin with the one or more acidophilic bacteria comprises contacting the lignin with one or more enzymes produced by the acidophilic bacteria.

35. (canceled)

36. The method of claim 21, wherein the one or more alkalophilic bacteria comprises Azobacter, Bacillus, pseudomonas, Synechococcus, Bacillus firmus RAB, Spirulina spp, Alicyclobacillus or any combination thereof.

37. The method of claim 21, wherein contacting the lignin with the one or more alkalophilic bacteria comprises contacting the lignin with one or more enzymes produced by the alkalophilic bacteria, wherein the one or more enzymes comprise alkaline protease, alkaline, cellulose, alkaline amylase, sulfurylase, phosphorylase, alkaline xylanase, cellulose, or any combination thereof.

38. (canceled).

39. The method of claim 37, further comprising acclimating the one or more bacteria before contacting with the lignin.

40. The method of claim 37, wherein contacting the lignin with one or bacteria produces oxidized lignin as the modified lignin, and at least one of R′₁, R′₂, R′₃, or R′₄ is substituted with one or more oxygen-containing functional groups.

41. The method of claim 40, wherein the one or more oxygen-containing functional groups comprise one or more carboxyl groups, one or more phenolic groups, one or more carbonyl (C═O) groups, one or more (—CH═CHOH) groups, one or more methoxyl (—OCH₃) groups, or any combination thereof.

42. The method of claim 21, wherein contacting the lignin with one or more bacteria produces sulfonated lignin as the modified lignin, and at least one of R′₁, R′₂, R′₃, or R′₄ is substituted with one or more sulfonic acid functional groups.

43. The method of claim 21,
wherein the lignin is waste lignin, wherein the waste lignin is a liquid.

44.-88. (canceled)

89. The method of claim 21, wherein contacting the lignin with one or more bacteria at a reaction temperature of about 5° C. to about 60° C. and a reaction time of about 5 hours to about 80 hours to produce a modified lignin having at least one of R′₁, R′₂, R′₃, or R′₄ substituted with one or more functional groups.
